(19) United States
(12) Patent Application Publication
(10) Pub. No.: US 2012/0253834 A1
(43) Pub. Date: Oct. 4, 2012

(54) METHODS, APPARATUSES AND COMPUTER PROGRAM PRODUCTS FOR FACILITATING DISPLAY OF RELEVANT QUALITY MEASURES BASED ON DIAGNOSES

(75) Inventors: Carrie L. Tracy, Anthem, AZ (US); Aron Ralston, Alameda, CA (US); Abel Martin Robertson, Oakland, CA (US); Steven Richard Silverstein, Englewood, CO (US)

(73) Assignee: McKesson Financial Holdings

(21) Appl. No.: 13/077,156

(22) Filed: Mar. 31, 2011

(51) Int. Cl. G06Q 50/00

(52) U.S. Cl. 705/2

(57) ABSTRACT

An apparatus is provided for generating one or more preventive health care plans. The apparatus includes at least one memory and at least one processor configured to receive medical information, associated with one or more patients, from different medical entities. The processor is further configured to identify whether data in the received medical information indicates that the medical information corresponds to at least one patient. The data comprises one or more unique identifiers identifying the patient. The processor is further configured to determine at least one medical condition or age/gender criteria of the patient based in part on one or more unique codes in the received medical information and generate at least one preventive health care plan on behalf of the patient based in part on the determined medical condition and one or more defined measures associated with the codes. Corresponding computer program products and methods are also provided.

### TECHNOLOGICAL FIELD

Embodiments of the invention relate generally to a mechanism of providing health care management and more particularly relate to a method, apparatus and computer program product for generating one or more preventive health care plans associated with patients.

### BACKGROUND

Currently, health care facilities may utilize preventive health care systems designed to perform actions with a goal of preventing diseases, injuries, or medical conditions from occurring in patients as well as managing existing diseases, injuries or medical conditions of patients. At present, a health care facility maintaining a preventive health care system typically utilizes information that the health care facility has obtained or generated on behalf of patients to develop preventive health management plans for patients. In this regard, current preventive health care systems typically utilize patient medical information obtained from a single source, such as, for example, a health care facility maintaining the preventive health care system to develop preventive health management plans. For example, the preventive health care system of a clinic may determine that a doctor of a clinic diagnosed a patient as having a disease. As such, the preventive health care system of the clinic may utilize this information to develop a preventive health care plan related to the disease.

One drawback of this approach is that the preventive health management plan may not be as robust or thorough as possible because the medical information utilized to generate the preventive health management plan may be obtained from a single source (e.g., a clinic). As such, the preventive health management plan may not be inclusive of other relevant patient information that may be stored by external health care systems. However, medical data associated with a patient(s) may typically be available from multiple medical sources. As such, the preventive health management plan may not be inclusive of other relevant patient information that may be stored externally by these medical sources.

Oftentimes a patient may visit various physicians (e.g., a primary doctor, a specialist, etc.) at different medical entities in which different diagnoses may be made and managed. Also, the patient may utilize various pharmacies for filling prescriptions and may receive medical laboratory results from different labs. As such, it may be beneficial to obtain the medical information associated with patients from these various medical sources in order to generate a more robust or thorough preventive health management plan that may be based on the integrated or aggregated medical information of the various medical sources.

Additionally, some of the current preventive health care systems include stand-alone applications that may provide one or more alerts or pop-ups to health care professionals to perform actions as part of a preventive health management plan. A drawback of the preventive health care systems utilizing these stand-alone applications is that the applications are typically poorly integrated into a health care professional's workflow.

For instance, health care professionals may need timely and easy access to information about patients in a manner that does not interrupt their normal workflow processes in order to improve preventive health management decisions. However, the alerts and pop-ups generated by the stand-alone applications may be interruptive in nature. For instance, typically the alerts and pop-ups generated by the stand-alone applications prompt a health care professional for a response upon receipt. In instances in which the alerts and pop-ups are received too frequently during a health care professional's workflow, the health care professional may experience alert fatigue. As such, alerts and pop-ups provided by the stand-alone applications of current health care systems may be burdensome and may have the undesirable effect of agitating a health care professional. In an instance in which the alerts or pop-ups are too interruptive, the health care professional may ignore the alerts or pop-ups. Ignoring the alerts or pop-ups may have the undesirable effect of the health care professional not performing an action(s) related to a patient's health in a timely manner or not performing the action at all, for example, in an instance in which the health care professional forgets about the alerts or pop-ups. As such, it may be beneficial to provide a less-intrusive mechanism of alerting health care professionals about information pertaining to preventive health management plans of patients.

Other drawbacks of the stand-alone applications of some of the current preventive health care systems is that decision support interventions provided by the stand-alone applications may not be tightly coupled to actions. In this regard, for example, a health care professional may not have the ability to immediately order a medication triggered by an alert or pop-up. In addition, an alert or pop-up generated by the stand-alone applications may not be immediately customizable for an individual patient.

In view of the foregoing drawbacks, it may be beneficial to provide an efficient and reliable mechanism for generating one or more preventive health care plans based in part on medical data that may be integrated or aggregated from multiple sources and for alerting health care professionals about relevant medical information, regarding the patients associated with the health care plans, in a non-intrusive manner.

### BRIEF SUMMARY

A method, apparatus and computer program product are therefore provided that may enable the provision of an efficient and reliable mechanism for generating one or more quality of care grids (also referred to herein as “preventive health care plans”). The quality of care grids may be aimed at preventing health problems of patients as well as managing existing health conditions of patients. An example embodiment may utilize aggregated medical data received from various different entities or sources (e.g., medical entities, pharmacies, laboratories, etc.) to generate quality of care grids associated with corresponding patients.

An example embodiment may analyze the aggregated medical data received from the different sources to identify one or more patients corresponding to the medical data. The identity of the patients may be determined based on one or more respective unique patient identifiers identifying the patients. Additionally, the medical data received from the various different sources may include one or more unique codes. The codes may be utilized to determine one or more medical conditions associated with a corresponding patient(s) based on the aggregated medical data received from the various different sources. Additionally, the codes may include data, or may be associated with, one or more defined care measures (also referred to herein as “measures”, “defined measures” or “quality of care measures”) associated with respective medical conditions. The care measures may be recommended measurements, tests or actions, etc. that should be performed to help prevent health problems associated with a medical condition(s) of a patient. The care measures may be associated with corresponding goals (e.g., a target value for a medical exam) that the patient should meet in order to manage their health as well as one or more corresponding intervals (e.g., time intervals) in which the measures should occur.

An example embodiment may facilitate inclusion of the care measures, the corresponding goals and intervals in the quality of care grids. Additionally, an example embodiment may receive an indication of one or more results associated with the goals for care measures and may include one or more values of the results in the quality of care grids. An example embodiment may provide one or more devices of health care professionals (e.g., clinicians, nurses, physicians, therapists, etc.) a quality of care grid(s) as a tool serving as a beneficial preventive care maintenance program associated with a patient(s). In this regard, a health care professional may utilize the quality of care grid(s) to track or monitor the progress of a patient's health related to one or more medical conditions. In an example embodiment, a patient may access a quality of care grid that may be generated on behalf of the patient in order to monitor their progress.

The quality of care grids may include one or more status indicators indicating a status as to whether a patient met the goals associated with the care measures. The status indicators may include different shapes and items of visible indicia (e.g., colors). In this regard, an example embodiment may utilize the shapes and the items of visible indicia to denote whether the patient met a goal(s), is close to meeting the goal(s) or did not meet the goal(s). The status indicators may serve as non-intrusive alerts to health care professionals relating to the health conditions of a patient(s).

In one exemplary embodiment, a method for generating one or more preventive health care plans is provided. The method may include receiving medical information, associated with one or more patients. The medical information may be received from one or more different medical entities. The method may further include identifying whether data in the received medical information indicates that the medical information corresponds to at least one of the patients. The data may include one or more unique identifiers identifying the at least one patient. The method may further include determining at least one medical condition or age or gender criteria of the at least one patient based in part on one or more unique codes in the received medical information and generating at least one preventive health care plan on behalf of the patient. The preventive health care plan may be based in part on the determined medical condition and one or more defined measures associated with the codes.

In another exemplary embodiment, an apparatus for generating one or more preventive health care plans is provided. The apparatus may include a memory and a processor configured to cause the apparatus to receive medical information, associated with one or more patients. The medical information may be received from one or more different medical entities. The processor is further configured to cause the apparatus to identify whether data in the received medical information indicates that the medical information corresponds to at least one of the patients. The data may include one or more unique identifiers identifying the at least one patient. The processor is further configured to cause the apparatus to determine at least one medical condition or age or gender criteria of the at least one patient based in part on one or more unique codes in the received medical information and generate at least one preventive health care plan on behalf of the patient. The preventive health care plan may be based in part on the determined medical condition and one or more defined measures associated with the codes.

In another exemplary embodiment, a computer program product for generating one or more preventive health care plans is provided. The computer program product includes at least one computer-readable storage medium having computer-executable program code instructions stored therein. The computer-executable program code instructions may include program code instructions configured to facilitate receipt of medical information, associated with one or more patients. The medical information may be received from one or more different medical entities. The computer program product may further include program code instructions configured to identify whether data in the received medical information indicates that the medical information corresponds to at least one of the patients. The data may include one or more unique identifiers identifying the at least one patient. The computer program product may further include program code instructions configured to determine at least one medical condition or age or gender criteria of the at least one patient based in part on one or more unique codes in the received medical information and generate at least one preventive health care plan on behalf of the patient. The preventive health care plan may be based in part on the determined medical condition and one or more defined measures associated with the codes.

Embodiments of the invention may provide a method, apparatus and computer program product for enabling an efficient and reliable manner in which to generate one or more preventive health care plans. As such, health care professionals may enjoy improvements in tracking or monitoring patient actions with the goal of preventing health care problems or minimizing the effect of existing health care problems for patients.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of communication device according to an exemplary embodiment of the invention;

FIG. 3 is a schematic block diagram of a computing device according to an exemplary embodiment of the invention;

FIG. 4 is a diagram of a user interface illustrating a quality of care grid according to an exemplary embodiment of the invention; and

FIG. 5 is a flowchart of an exemplary method for generating a preventive health care plan according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### General System Architecture

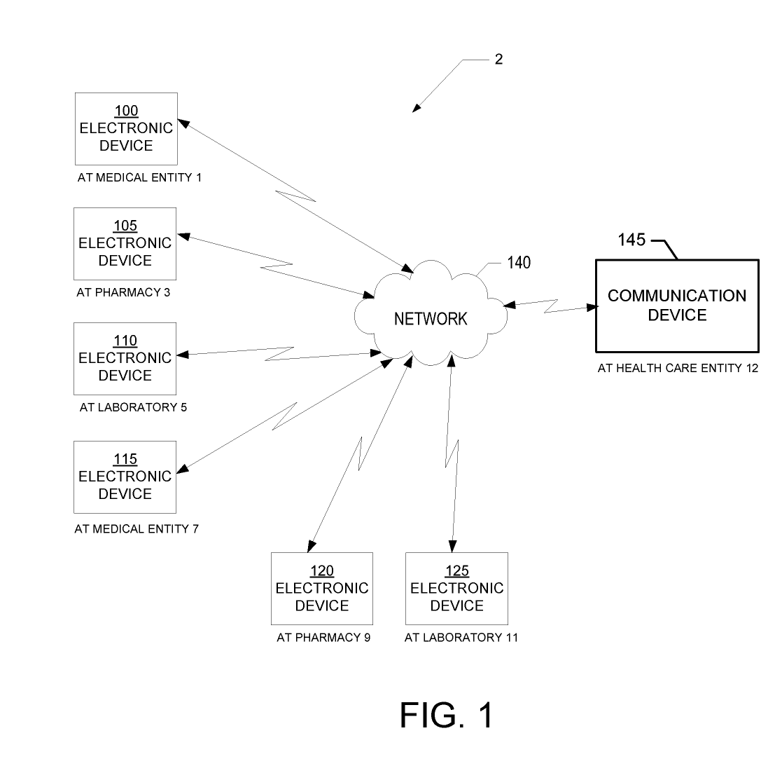

Reference is now made to FIG. 1, which is a block diagram of a system according to exemplary embodiments. As shown in FIG. 1, the system 2 may include one or more electronic devices 100, 105, 110, 115, 120 and 125 (e.g., personal computers, laptops, workstations, servers, personal digital assistants, smart devices and the like, etc.) which may access one or more network entities such as, for example, a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). In this regard, the communication device 145 is capable of receiving data from and transmitting data to the electronic devices 100, 105, 110, 115, 120 and 125 via network 140. In one exemplary embodiment, the electronic devices 100, 105, 110, 115, 120 may be utilized by clinicians, nurses, pharmacists, physicians, physical therapists and/or any other suitable health care professionals. The electronic devices 100, 105, 110, 115, 120, 125 may be maintained by one or more health care institutions. For instance, the electronic device 100 may be maintained by a medical entity 1, the electronic device 105 may be maintained by a pharmacy 3, the electronic device 110 may be maintained by the laboratory 5. Additionally, the electronic device 115 may be maintained by a medical entity 7, the electronic device 120 may be maintained by a pharmacy 9 and the electronic device 125 may be maintained by the laboratory 11. In an exemplary embodiment, the communication device 145 may be maintained by a health care entity 12. In an alternative exemplary embodiment, the communication device 145 may be maintained by any other suitable entity.

The communication device 145 may communicate with the electronic devices 100, 105, 110, 115, 120, 125. In this regard, the communication device 145 may receive medical information from and may transmit medical information to the electronic devices 100, 105, 110, 115, 120, 125. The medical information may be utilized by the communication device 145 to generate one or more quality of care grids. The quality of care grids (also referred to herein as preventive health care plans) may be associated with respective patients. The quality of care grids may be generated based in part on the aggregated medical information and/or patient demographic data received from one or more of the electronic devices 100, 105, 110, 115, 120 and 125, as described more fully below. The aggregated medical information may be associated with respective patients.

It should be pointed out that although FIG. 1 shows six electronic devices 100, 105, 110, 115, 120, 125 and one communication device 145 any suitable number of electronic devices 100, 105, 110, 115, 120, 125 and communication devices 145 may be part of the system of FIG. 1 without departing from the spirit and scope of the invention. For example, a patient may utilize an electronic device to communicate with the communication device 145 to access or obtain a quality of care grid generated by the communication device 145 on behalf of the patient. In this regard, the patient may view the grid to monitor their health progress associated with one or more medical conditions.

### Communication Device

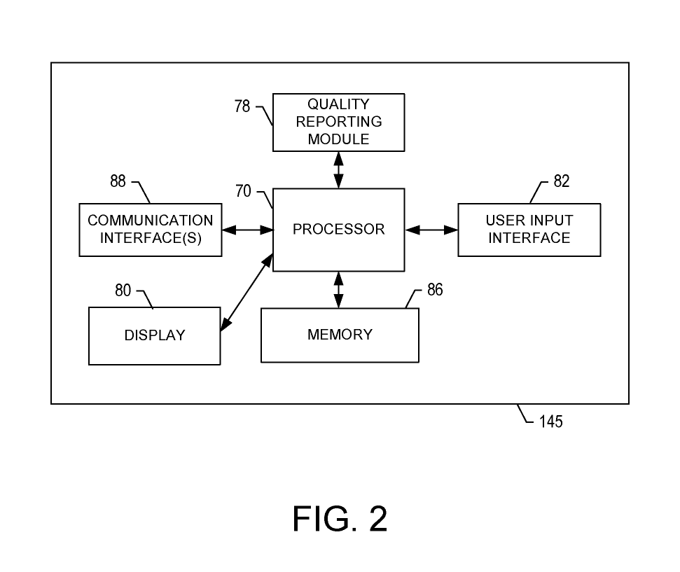

FIG. 2 illustrates a block diagram of a communication device according to an exemplary embodiment of the invention. The communication device 145 may, but need not, be a network entity such as, for example, a server. The communication device 145 includes various means for performing one or more functions in accordance with exemplary embodiments of the invention, including those more particularly shown and described herein. It should be understood, however, that one or more of the communication devices may include alternative means for performing one or more like functions, without departing from the spirit and scope of the invention. More particularly, for example, as shown in FIG. 2, the communication device 145 may include a processor 70 connected to a memory 86. The memory may comprise volatile and/or non-volatile memory, and typically stores content (e.g., media content), data, information or the like.

For example, the memory may store content transmitted from, and/or received by, the electronic devices 100, 105, 110, 115, 120 and 125. In this regard, in an exemplary embodiment, the memory 86 may store data received from various disparate sources. For example, the memory 86 may store medical information received by the communication device 145 from the electronic devices of the medical entity 1, the pharmacy 3, the laboratory 5, the medical entity 7, the pharmacy 9 and the laboratory 11. The medical information may include medical diagnoses, laboratory results, medical tests or measurements, medical chart information (e.g., clinician assessments, vital signs, etc.), prescription data, medical imaging data (e.g., X-rays of the human body), alert information and any other suitable information.

The medical information associated with the medical diagnoses, laboratory results, medical tests or measurements, medical chart information, prescription data, medical image data and alert information may also include data corresponding to dates and times this information was created or the actual dates and times of actual events (e.g., actual date and time of a laboratory result) associated with the generation of this information. Additionally, the medical information may also include, but is not limited to, data associated with admission of a patient into a medical institution and a corresponding date and time of admission and/or discharge of a patient from a medical facility as well as a corresponding date and time of discharge.

Additionally, the medical information may include, but is not limited to, one or more medical events or procedures (e.g., surgical procedures) and may indicate one or more dates and times of these events or procedures, transfers from different medical units (e.g., critical to telemetry, critical to medical surgery (Med-Surg), telemetry to critical, etc.) within a facility (e.g., hospital) and corresponding date and times of such transfer(s), expected or forecasted discharge dates and times, tasks that remain unmet, one or more pre-admission events and corresponding dates and times as well as any other suitable medical information. The medical information received by the communication device 145 from the electronic devices 100, 105, 110, 115, 120, 125 may include one or more unique patient identifiers. The patient identifiers may identify respective patients. In an example embodiment, the patient identifiers may be one or more unique alphanumeric characters used to denote the identity of respective patients. For instance, a patient identifier such as, for example, 12ABC310 may identify a patient such as, for example, Jane Doe (e.g., a fictitious person as referred to herein). Additionally, or alternatively Medical Record Numbers (MRNs) may be utilized as patient identifiers to identify corresponding patients.

Also for example, the memory 86 typically stores client applications, instructions, algorithms or the like for execution by the processor 70 to perform steps associated with operation of the communication device 145 in accordance with embodiments of the invention. As explained below, for example, the memory 86 may store one or more client applications such as for example software (e.g., software code also referred to herein as computer code).

The processor 70 may be embodied in a variety of ways. For instance, the processor 70 may be embodied as a controller, coprocessor microprocessor of other processing devices including integrated circuits such as, for example, an application specific integrated circuit (ASIC), a field programmable gate array (FPGA). In an exemplary embodiment, the processor may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other devices such as, for example, electronic devices 100, 105, 110, 115, 120, 125 over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network.

In addition to the communication interface(s), the interface(s) may also include at least one user interface that may include one or more earphones and/or speakers, a display 80, and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a quality reporting module 78. The quality reporting module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the quality reporting module 78, as described below. In examples in which software is employed, a device or circuitry (e.g., processor 70 in one example) executing the software forms the structure associated with such means. As such, for example, the quality reporting module 78 may be configured to, among other things, generate one or more quality of care grids based in part on aggregated data received from multiple different entities/sources such as the electronic devices 100, 105, 110, 115, 120, 125 maintained respectively by the medical entity 1, the pharmacy 3, the laboratory 5, the medical entity 7, the pharmacy 9 and the laboratory 11, as described more fully below.

The quality of care grids generated by quality reporting module 78 may be a preventive health care plan for a corresponding patient(s). Based on a patient's medical condition (e.g., diabetes) and other relevant patient information (e.g., information identifying medications taken by the patient, etc.), the quality reporting module 78 may generate the quality of care grids to include data identifying goals and service intervals for the patient based on established measured standards, as described more fully below. The goals may, but need not, be generated based on standards associated with a determined medical condition(s).

The quality reporting module 78 may generate a quality of care grid(s) based in part on medical information associated with a corresponding patient that the quality reporting module 78 may receive from one or more various sources (e.g., medical entity 1, pharmacy 3, laboratory 5, medical entity 7, pharmacy 9, laboratory 11, etc.) as well as based on medical information associated with the patient obtained from the health care entity 12. The quality reporting module 78 may determine that the medical information is associated with a corresponding patient based on a patient identifier in the medical information. In this regard, the patient identifier may identify the corresponding patient, as described above.

The quality reporting module 78 may receive the medical information, utilized to generate the quality of care grids, from one or more sources (e.g., medical entity 1, pharmacy 3, laboratory 5, medical entity 7, pharmacy 9, laboratory 11, etc.) automatically in response to the electronic devices of the sources determining that data (e.g., existing data or new data) associated with a corresponding patient is available.

In an example embodiment, the quality reporting module 78 may utilize one more best matching algorithms and virtualization techniques to process incomplete data. For example, many reporting measures may require that each of the procedures, diagnoses, and other health information of the medical information, received from different entities (e.g., medical entity 1, pharmacy 3, laboratory 5, medical entity 7, pharmacy 9, laboratory 11, etc.), associated with a patient be tied to an “encounter” or “visit” with a health care provider. In this regard, the quality reporting module 78 may automatically create one or more virtual encounter entities (referred to herein as “PatientInteractions”) to link the activities together even if no actual “encounter” or “visit” is recorded. The quality of reporting module 78 may utilize a virtual encounter entity (e.g., PatientInteraction entity) to link a patient, provider (e.g., doctor), practice (e.g., medical clinic) and date of service together based on a unique identifier such as, for example, a PatientInteraction identifier. This PatientInteraction identifier may be automatically embedded, by the quality reporting module 78, in all of the associated health data of the medical information (e.g., procedures, diagnoses, medications, etc.) in a memory (e.g., memory 86) as the data is recorded, by the quality reporting module 78, allowing the quality reporting module 78 to quickly and easily link this data together at a later point (such as, for example, when reports are generated). Since much of the medical information may include patient data that may originate externally, the quality reporting module 78 may choose the best matching provider or best matching practice (e.g., if this information is missing from the source data) in order to locate an existing, or to create the, virtual encounter entity (e.g., PatientInteraction entity). In this regard, the quality reporting module 78 may determine the best practice (e.g., given a patient and provider) or the best provider (e.g., given a patient and a practice).

### Computing Device

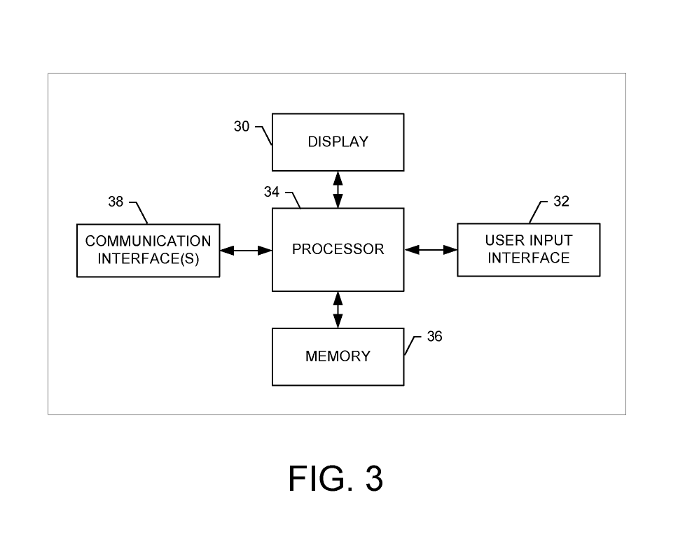

Referring now to FIG. 3, a block diagram of a computing device according to an exemplary embodiment is provided. The computing device is capable of operating as any of electronic devices 100, 105, 110, 115, 120 and 125. In this regard, the electronic devices 100, 105, 110, 115, 120, and 125 may comprise the elements of the computing device of FIG. 3. As shown in FIG. 3, the computing device may include a processor 34 connected to a memory device 36. The memory device 36 (also referred to herein as memory 36) may comprise volatile and/or non-volatile memory, and may store content, information, data or the like. For example, the memory device 36 typically stores content transmitted from, and/or received by, the computing device. Additionally, the memory device 36 may store client applications, software (e.g., software code) algorithms, instructions or the like for the processor 34 to perform steps associated with operation of the computing device.

The memory device 36 may store medical information (e.g., medical diagnoses, laboratory results, medications, etc.) associated with one or more patients. The medical information may include one or more patient identifiers identifying respective patients (e.g., Jane Doe). The medical information may also include one or more codes that may be defined to designate and identify medical data. For example, the unique codes may designate and identify specific diseases (e.g., diabetes), injuries, conditions, types of medications (e.g., amoxicillin), types of laboratory results and any other suitable medical data. In an exemplary embodiment, at least some of the codes may be International Statistical Classification of Diseases and Related Health Problems (ICD) 9 (ICD-9) codes which may classify diseases, a variety of signs, symptoms, abnormal findings, complaints, causes of injury or disease, social circumstances and any other suitable health care data. In this regard, health conditions may be assigned a unique category and a code (e.g., six characters in length, or any other suitable length).

The codes may also be associated with, or may include, one or more defined quality measures that may be utilized to drive or assign specific items to be measured (e.g., performing an eye exam, etc.) for an individual patient. In an example embodiment, the measures may include but are not limited to Centers for Medicare/Medicaid Services (CMS) Physician Quality Reporting Initiative (PQRI) measures, National Center for Quality Assurance (NCQA) National Quality Forum (NQF) measures and any other suitable measures. In an example embodiment, the defined measures may include data associated with numerator criteria and denominator criteria. The denominator criteria may include data defining a patient population that may apply to a corresponding measure, which may be based on a medical condition/disease, etc. (e.g., diabetes). The numerator criteria may be associated with data indicating a percentage of patients that meet the goals of the measure.

In an instance in which medical information that may include the codes and the defined measures may be sent to the communication device 145, by the processor 34, the quality reporting module 78 may detect a code(s) with a defined quality measure and based in part on the data associated with the code(s) and the defined measures, the quality reporting module 78 may assign a number of measures to be taken or performed for a corresponding patient. The measures to be taken or performed for a patient may be included in a quality of care grid by the quality reporting module 78, as described more fully below. The quality reporting module 78 may also include goals for the measures as well as due dates and time intervals in which the measures should be completed.

The processor 34 may be connected to at least one communication interface 38 or other means for displaying, transmitting and/or receiving data, content, information or the like. In this regard, the communication interface 38 may be capable of connecting to one or more networks. The computing device may also include at least one user input interface 32 that may include one or more speakers, a display 30, and/or any other suitable devices. For instance, the user input interface 32 may include any of a number of devices allowing the computing device to receive data from a user, such as a keyboard, a keypad, mouse, a microphone, a touch screen display, or any other input device.

The processor 34 may send medical information associated with one or more patients to the communication device 145 in response to determining that medical information is available for corresponding patients. In an example embodiment, the processor 34 may automatically send medical information associated with one or more patients to the communication device 145 in response to determining that medical information for a patient(s) is available. The processor 34 may determine that medical information is available in response to determining that medical data associated with a patient identifier(s) identifying a patient(s) is stored in a memory (e.g., memory device 36). In this regard, when the processor 34 detects newly stored data, in the memory, that is associated with a patient(s), the processor 34 may automatically send the data to the communication device 145.

### Exemplary System Operation

Exemplary embodiments of the invention may provide an efficient and reliable mechanism for generating one or more quality of care grids. The quality of care grids may be aimed at preventing health problems of patients as well as managing existing health conditions of patients. The exemplary embodiments may utilize patient medical data received from various sources (e.g., medical entity 1, pharmacy 3, laboratory 5, medical entity 7, pharmacy 9, laboratory 11, etc.) to generate the quality of care grid. By utilizing aggregated medical data received from multiple sources to generate the quality of care grid, the quality of care grid of the example embodiments may be more robust and inclusive of a patient's medical condition(s) than a patient health care plan generated based on data obtained from a single source.

Additionally, the exemplary embodiments may include one or more status indicators on a quality of care grid indicating a status of one or more measures associated with a patient. In this regard, the status indicators may serve as non-intrusive alerts to health care professionals relating to health conditions pertaining to an associated patient. In one example embodiment, a quality of care grid may, but need not, be presented to a display (e.g., display 30) by a processor (e.g., processor 34) of a device (e.g., electronic device 100) utilized by a health care professional within a progress note while a corresponding patient is visiting the health care professional, for example. The health care professional may utilize the quality of care grid to analyze measures that may reflect one or more known diagnoses, problems, or preventive care needs related to the patient.

Also, for example, the quality of care grid may be provided in an electronic patient chart or electronic patient record for review by a health care professional. Although the health care professional may evaluate the status indicators of the quality of care grid associated with a patient (e.g., Jane Doe) while the health care professional may be examining the patient (e.g., Jane Doe), it should be pointed out that a quality of care grid may be accessible and reviewed by a health care professional at any suitable time, e.g., times other than when a patient may be visiting the health care professional.

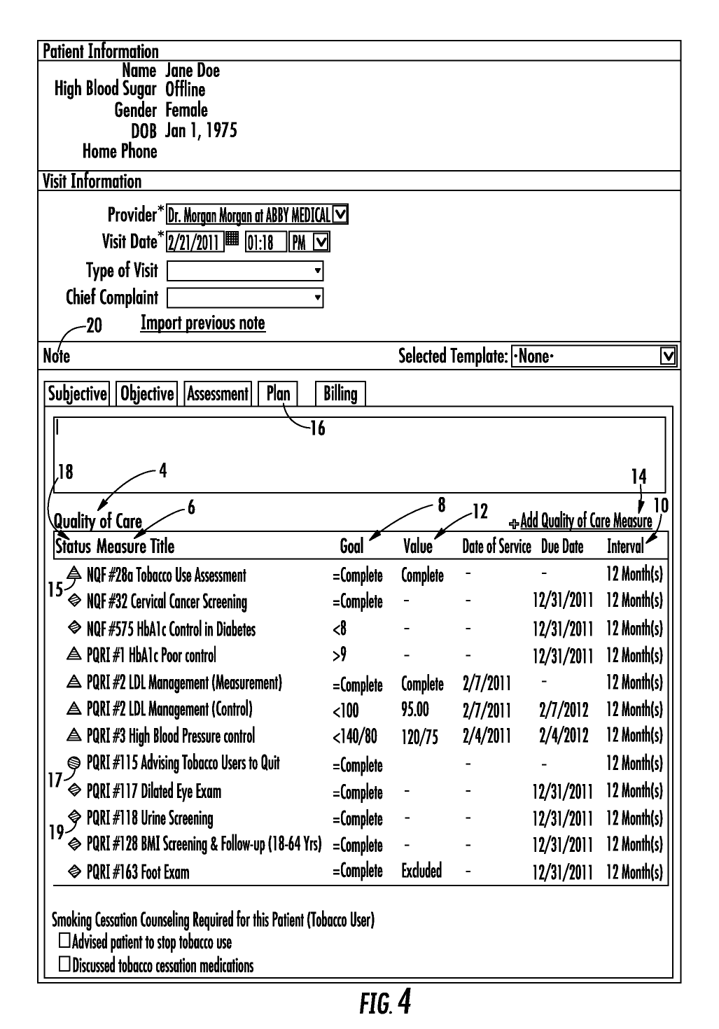

As an example in which the quality reporting module 78 may generate a quality of care grid(s) associated with a patient, consider FIG. 4 described more fully below for purposes of illustration and not of limitation.

Referring now to FIG. 4, an exemplary embodiment of a user interface indicating a quality of care grid is provided. The quality reporting module 78 may generate the quality of care grid 4. In an example embodiment, the quality reporting module 78 may generate the quality of care grid 4 in response to receipt of a selection of a preventive health care plan tab 16 (also referred to herein as “plan tab 16”). In an example embodiment, the electronic devices 100, 105, 110, 115, 120, 125 of the medical entity 1 (e.g., a hospital), pharmacy 3, laboratory 5, medical entity 7 (e.g., a medical clinic), pharmacy 9, laboratory 11, respectively may store medical information associated with one or more patients.

For purposes of illustration and not of limitation, the electronic device 100 of medical entity 1 may store medical information such as, for example, a diagnosis as provided by a physician on behalf of a patient (e.g., Jane Doe), whereas the electronic device 115 of medical entity 7 may store another diagnosis as provided by another physician on behalf of the patient. In this example embodiment, presume that the physicians of the medical entities 1 and 7 both diagnosed the patient with a medical condition such as, for example, diabetes. The electronic devices 100 and 115 may also store other medical information associated with a patient(s) including, but not limited to, other diagnoses, patient history data, medications prescribed to the patient, lab results, etc. The electronic device 105 of the pharmacy 3 and the electronic device 120 of the pharmacy 9 may store medication data associated with prescriptions filled on behalf of the patient. In this regard, the pharmacies 3, 9 may identify medications taken by the patient. The electronic device 110 of the laboratory 5 and the electronic device 125 of the laboratory 11 may store lab results generated on behalf of a patient. In response to the electronic devices 100, 105, 110, 115, 120, 125 determining, via a processor (e.g., processor 34), that this medical information associated with a patient(s) is being stored in a memory (e.g., memory device 36) and is available, the processor of the electronic devices may send the medical information to the communication device 145.

The medical information sent by the electronic devices 100, 105, 110, 115, 120, 125 to the communication device 145 may be aggregated and may include one or more patient identifiers (e.g., 123ABC3) identifying a corresponding patient(s) (e.g., Jane Doe) that the medical information is related to. Additionally, the aggregated medical information received by the communication device may include one or more codes associated with or including one or more defined measures. In this example embodiment, the quality reporting module 78 may analyze data of the codes (e.g., NQF codes, PQRI codes, etc.) in the medical information to identify the diagnoses, the medications taken by the patient, the nature or type of lab results generated on behalf of the patient and any other suitable data. In this example embodiment, presume that quality reporting module 78 analyzed one or more diagnosis codes of the codes and determined that the diagnosis codes identified diabetes, which may correspond to the diagnoses of the physicians of medical entities 1 and 7. Also, for example, presume that the quality reporting module 78 evaluated one or more medication codes of the codes and determined that the medication codes identified one or more medications for the treatment of diabetes as medications either currently prescribed or prescribed in the past to the patient.

In this example, also presume that the quality reporting module 78 evaluated one or more lab codes of the codes and determined that the lab codes identified tests related to diabetes (e.g., measuring insulin levels). Based on the evaluation of the codes by the quality reporting module 78, the quality reporting module 78 may determine that a patient(s) associated with the medical information received from the electronic devices has and/or is being treated for diabetes. In this regard, the quality reporting module 78 may analyze data corresponding to defined measures associated with one or more of the codes (e.g., a diagnosis code) and may determine one or more measures that should be performed for the patient.

In the example embodiment of FIG. 4, the quality reporting module 78 may determine that the measures may relate to a tobacco use assessment, a cervical cancer screening, a glycated hemoglobin (HbA1c) control in diabetes measurement, a HbA1c poor control measurement, a low-density lipoprotein (LDL) management measurement, a LDL management control measurement, a high blood pressure control measurement, a dilated eye exam, a body mass index (BMI) screening and follow up measurement, a foot exam or any other suitable measures.

The quality reporting module 78 may include the determined measures in the measure title field 6 of the quality of care grid 4. The quality reporting module 78 may include the standard goals and service intervals for the measures to be performed for a patient(s) in the quality of care grid. The standard goals 8 and service intervals 10 may be generated in response to retrieval of data, by the quality reporting module 78, associated with the defined measures of the codes (e.g., NQF codes, PQRI codes, etc.) In response to receipt of data indicating the results of one or more measures, the quality reporting module 78 may include the data indicating the results of the measures in the value field 12 of the quality of care grid 4. For example, in response to the quality reporting module 78 receiving data indicating that the LDL management control measure has been performed, the quality reporting module 78 may include the results of this measure, which is 95.00 in this example embodiment, on the quality of care grid 4. As shown, in the quality of care grid 4, the result of the value (e.g., 95.00) meets the standard goal (e.g., <100) measurement.

It should be pointed out that some the goals associated with the measures may not relate to any numerical result(s) but instead may relate to completion of the goal. For instance, the standard goal of the tobacco use assessment measure may be to complete the measure and in response to receipt of data indicating that the measure is completed, the quality reporting module 78 may include data in the quality of care grid 4 indicating that the result is “Complete”. In an instance, in which the quality of care grid 4 receives an indication that a result associated with a standard goal is not applicable, the quality reporting module 78 may include data in the quality of care grid 4 indicating the that value is “Excluded”. For instance, presume that the foot of the patient (e.g., Jane Doe), associated with the quality of care grid 4, is amputated. In this regard, the quality of care grid 4 may receive an indication that a result associated with a standard goal related the foot exam measure is not applicable. As such, the quality reporting module 78 may include data in the quality of care grid 4 indicating the value is “Excluded”.

The quality reporting module 78 may include one or more status indicators in the status field 18. The status indicators may serve as alerts to one or more health care professionals (e.g., a physician(s)) regarding the status of the measures of the quality of care grid 4. The quality reporting module 78 may generate the status indicators with one or more shapes (e.g., a triangle(s), a rhombus(es), a circle(s), etc.) and one or more items of visible indicia (e.g., colors (e.g., indicated by cross-hatchings)). For purposes of illustration and not of limitation, a first shape/item of visible indicia (e.g., the color green) may be utilized by the quality reporting module 78 to denote that a goal for a particular measure is met. A second shape/item of visible indicia (e.g., the color yellow) may be utilized by the quality reporting module 78 to denote that a goal for a particular measure is close to being met, approached or reached. In this regard, a health care professional of an entity (e.g., medical entity 1) may utilize an electronic device (e.g., electronic device 100) to set a threshold designated as approaching the goal, as described more fully below. A third shape/item of visible indicia (e.g., the color red) may be utilized by the quality reporting module 78 to denote that a goal corresponding to a particular measure is not being met.

In this regard, for example, the status indicator 15 generated by the quality reporting module 78 may have a shape such as, for example, a triangle and a first item of visible indicia (e.g., green color) denoting that the patient met their goal for the tobacco use assessment measure. The status indicator 17 generated by the quality reporting module 78 may have a shape such as, for example, a circle and a second item of visible indicia (e.g., yellow color) denoting that the patient is approaching or close to meeting the goal associated with the advising tobacco users to quit measure. Also, for example, the status indicator 19 generated by the quality reporting module 78 may have a shape such as, for example, a rhombus and a third item of visible indicia (e.g., red color) denoting that the patient did not meet their goal for the urine screening measure. Although the status indicators of the grid 4 may be associated with three shapes and three items of visible indicia it should be pointed out that the status indicators may be associated with any suitable number of shapes and items of visible indicia without departing from the spirit and scope of the invention.

In response to generating the quality of care grid 4, the quality reporting module 78 may provide, or may make accessible, the generated quality of care grid 4 to one or more of the electronic devices 100, 105, 110, 115, 120, 125. For example, the quality reporting module 78 may provide the quality of care grid 4 to the medical entity 1. In this regard, the electronic device 100 of the medical entity 1 may enable display (e.g., via display 30) of the quality of care grid 4. The processor of the electronic device 100 may enable display of the quality of care grid 4 in a progress note 20 (also referred to herein as note 20), for example, utilized by a health care professional (e.g., a physician) of the medical entity 1. As such, a health care professional of the medical entity 1 may view and evaluate the quality of care grid 4 in a progress note 20 shown on a display of an electronic device (e.g., electronic device 100) while the patient is being evaluated. In an alternative example embodiment, the quality reporting module 78 may include the quality of care grid 4 in an electronic patient record associated with a corresponding patient and/or an electronic patient chart associated with a corresponding patient. However, in one example embodiment, it should be pointed out that the quality of care grid 4 may be viewed without being incorporated in a progress note, an electronic patient chart or an electronic patient record.

With regards to the status indicators of the quality of care grid 4, it should be pointed out that a health care professional of an entity may utilize an electronic device to define a threshold designated as approaching the goal associated with a particular measure, as described above. In this regard, for example, the health care professional may use a user input interface (e.g., user input interface 32) of an electronic device to define that a threshold such as, for example, a percentage (e.g., 80%) of the goal being met constitutes approaching the goal. As such, in an instance in which a processor of an electronic device may determine that a patient's results are within the threshold, the processor may associate the status indicator 17 with the corresponding measure.

Additionally, it should be pointed out that a health care professional may utilize an electronic device to adjust one or more standard goals and one or more intervals associated with one or more measures of the quality of care grid 4. In this regard, in response to receipt of an indication by the processor (e.g., processor 34) of an electronic device (e.g., electronic device 100) indicating that one or more goals or intervals are being changed, the processor of the electronic device may modify the corresponding goal(s) in the quality of care grid 4. The health care professional may utilize a user input interface (e.g., user input interface 32) of an electronic device (e.g., electronic device 100) to input a goal(s) and/or interval(s) that the health care professional may desire a particular measure(s) to relate to.

In this regard, for example, a processor of an electronic device (e.g., electronic device 100) may modify a goal associated with the HbA1c control in diabetes measure to <9 as opposed to the standard goal of <8. In this manner, a patient may encouraged that they are making progress towards the standard goal. When the patient achieves the modified goal, the goal may, but need not, be changed back to the standard goal in a like manner with the aim of continuing the patient's progress towards the standard goal.

Additionally, in an instance in which a health care professional may desire to include a measure that may not be initially included by the quality reporting module 78 on the quality of care grid 4, the health care professional may utilize a pointing device (e.g., a mouse) or the like of a user input interface (e.g., user input interface 32) of an electronic device (e.g., electronic device 100) to select the add quality of care measure link 14. In response to receipt of the selection of the add quality of care measure link 14, the quality reporting module 78 may add a selected or chosen care measure to the quality of care grid 4. As an example, a defined measure may not be included in or associated with one or more codes in the received medical information indicating that a mammogram measure is recommended because a standard may indicate that only patients over 40 years old may have an annual mammogram exam. Although the corresponding patient may be under 40 years old, the health care professional may still desire to track and monitor the mammogram measure for the patient in an instance in which the patient may have a family history of breast cancer, for example. As such, a processor of an electronic device utilized by the health care provider may add the mammogram measure to the quality of care grid 4 in response to receipt of a selection of the add quality of care measure link 14 and in response to receipt of a selection of the mammogram measure from a list of quality care measures.

As described above, a patient may utilize an electronic device to access a corresponding quality of care grid 4 generated on behalf of the patient. In this regard, the patient may track their health progress related to one or more medical conditions.

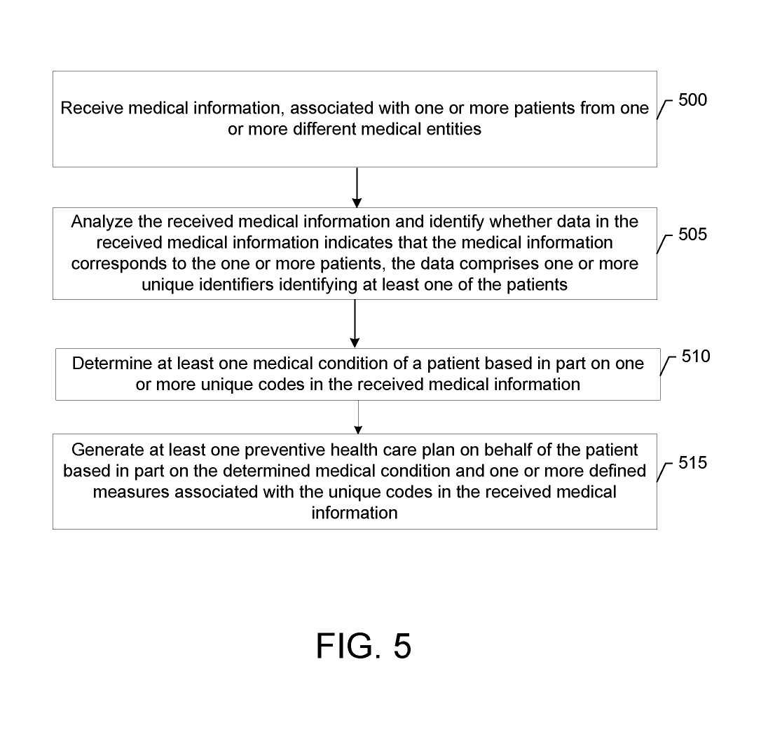

Referring now to FIG. 5, an exemplary method for generating one or more preventive health care plans is provided. At operation 500, an apparatus (e.g., communication device 145) may receive medical information, associated with one or more patients from one or more different medical entities (e.g., medical entity 1, pharmacy 3, laboratory 5, medical entity 7, pharmacy 9, laboratory 11, etc.). At operation 505, the apparatus may identify whether data in the received medical information indicates that the medical information corresponds to one or more patients. The data may include one or more unique identifiers identifying at least one of the patients (e.g., Jane Doe).

At operation 510, the apparatus may determine at least one medical condition (e.g., diabetes) of at least one patient based in part on one or more unique codes (e.g., PQRI codes, NQF codes) in the received medical information. At operation 510, the apparatus may generate at least one preventive health care plan (e.g., a quality of care grid 4) on behalf of the patient based in part on the determined medical condition and one or more defined measures (e.g., tobacco use assessment measure, HbA1c control in diabetes measure, etc.) associated with the unique codes in the received medical information.

It should be pointed out that FIG. 5 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86, memory 36) and executed by a processor (e.g., processor 70, processor 34, quality reporting module 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the methods of FIG. 5 above may comprise a processor (e.g., the processor 70, the processor 34, the quality reporting module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 34, the processor 70 (e.g., as means for performing any of the operations described above), the quality reporting module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving medical information, associated with one or more patients, from one or more different medical entities;
identifying whether data in the received medical information indicates that the medical information corresponds to at least one of the patients, the data comprises one or more unique identifiers identifying the at least one patient;
determining at least one medical condition or age or gender criteria of the at least one patient based in part on one or more unique codes in the received medical information; and
generating, via a processor, at least one preventive health care plan on behalf of the patient based in part on the determined medical condition and one or more defined measures associated with the codes.

2. The method of claim 1, further comprising:
enabling provision of the preventive health care plan to one or more apparatuses; and
enabling monitoring of performance results associated with the measures by at least one health care professional or the patient via at least one of the apparatuses.

3. The method of claim 1, further comprising:
including one or more quality of care measures, associated with the defined measures, in the preventive health care plan.

4. The method of claim 1, wherein:
the defined measures are included in the received medical information; and
the defined measures correspond to one or more preventive health care actions to be performed in order to monitor the health of the patient.

5. The method of claim 1, further comprising:
determining that each of the defined measures are associated with one or more respective goals established for the defined measures; and
including the goals in the preventive health care plan.

6. The method of claim 1, further comprising:
enabling addition of one or more quality of care measures to the preventive health care plan in response to receipt of a selection, even though the quality of care measures may not correspond to the defined measures.

7. The method of claim 1, further comprising:
analyzing data associated with one or more results of the goals; and
including the results in the preventive health care plan.

8. The method of claim 1, further comprising:
generating one or more status indicators comprising at least one of a shape or an item of visible indicia indicating whether the patient is currently meeting the goals; and
including at least one of the status indicators in the preventive health care plan in correspondence with a respective measure.

9. An apparatus comprising:
at least one memory; and
at least one processor configured to cause the apparatus to:
receive medical information, associated with one or more patients, from one or more different medical entities;
identify whether data in the received medical information indicates that the medical information corresponds to at least one of the patients, the data comprises one or more unique identifiers identifying the at least one patient;
determine at least one medical condition or age or gender criteria of the at least one patient based in part on one or more unique codes in the received medical information; and
generate at least one preventive health care plan on behalf of the patient based in part on the determined medical condition and one or more defined measures associated with the codes.

10. The apparatus of claim 9, wherein the processor is further configured to cause the apparatus to:
enable provision of the preventive health care plan to one or more apparatuses; and
enable monitoring of performance results associated with the measures by at least one health care professional or the patient via at least one of the apparatuses.

11. The apparatus of claim 9, wherein the processor is further configured to cause the apparatus to:
include one or more quality of care measures, associated with the defined measures, in the preventive health care plan.

12. The apparatus of claim 9, wherein:
the defined measures are included in the received medical information; and
the defined measures correspond to one or more preventive health care actions to be performed in order to monitor the health of the patient.

13. The apparatus of claim 9, wherein the processor is further configured to cause the apparatus to:
determine that each of the defined measures are associated with one or more respective goals established for the defined measures; and
include the goals in the preventive health care plan.

14. The apparatus of claim 9, wherein the processor is further configured to cause the apparatus to:
enable addition of one or more quality of care measures to the preventive health care plan in response to receipt of a selection, even though the quality of care measures may not correspond to the defined measures.

15. The apparatus of claim 9, wherein the processor is further configured to cause the apparatus to:
analyze data associated with one or more results of the goals; and
include the results in the preventive health care plan.

16. The apparatus of claim 9, wherein the processor is further configured to cause the apparatus to:
generate one or more status indicators comprising at least one of a shape or an item of visible indicia indicating whether the patient is currently meeting the goals; and
include at least one of the status indicators in the preventive health care plan in correspondence with a respective measure.

17. A computer program product comprising at least one computer-readable storage medium having computer-executable program code instructions stored therein, the computer executable program code instructions comprising:
program code instructions configured to facilitate receipt of medical information, associated with one or more patients, from one or more different medical entities;
program code instructions configured to identify whether data in the received medical information indicates that the medical information corresponds to at least one of the patients, the data comprises one or more unique identifiers identifying the at least one patient;
program code instructions configured to determine at least one medical condition or age or gender criteria of the at least one patient based in part on one or more unique codes in the received medical information; and
program code instructions configured to generate at least one preventive health care plan on behalf of the patient based in part on the determined medical condition and one or more defined measures associated with the codes.

18. The computer program product of claim 17, further comprising:
program code instructions configured to enable provision of the preventive health care plan to one or more apparatuses; and
program code instructions configured to enable monitoring of performance results associated with the measures by at least one health care professional or the patient via at least one of the apparatuses.

19. The computer program product of claim 17, further comprising:
program code instructions configured to include one or more quality of care measures, associated with the defined measures, in the preventive health care plan.

20. The computer program product of claim 17, wherein:
the defined measures are included in the received medical information; and
the defined measures correspond to one or more preventive health care actions to be performed in order to monitor the health of the patient.
